(19) United States
(12) Patent Application Publication
(10) Pub. No.: US 2023/0394676 A1
(43) Pub. Date: Dec. 7, 2023

(54) VIDEO ANALYZING DEVICE, VIDEO ANALYZING METHOD, AND NON-TRANSITORY COMPUTER READABLE MEDIUM

(71) Applicant: TOYODA GOSEI CO., LTD., Kiyosu-shi (JP)

(72) Inventors: Yoko KOMORI, Kiyosu-shi (JP); Katsuya SUGIYAMA, Kiyosu-shi (JP); Masatoshi SHIMADA, Kiyosu-shi (JP); Takayuki IWAHANA, Nagoya-shi (JP)

(21) Appl. No.: 18/201,384

(22) Filed: May 24, 2023

(30) Foreign Application Priority Data
Jun. 3, 2022 (JP) 2022-090725

(51) Int. Cl. G06T 7/20

(52) U.S. Cl. CPC G06T 7/20; G06T 2207/30224; G06T 2200/24; G06T 2207/10016; G06T 2207/20104

(57) ABSTRACT

A video analyzing device is configured to acquire information related to a motion of a target object based on a video showing the motion. The video analyzing device includes circuitry. The circuitry is configured to perform a video displaying process of displaying the video on a display screen of a display device; a region specifying process of specifying a part of a range shown in the video as a determination region; and an information acquiring process of acquiring the information based on a change in the specified determination region. The region specifying process includes specifying the part as the determination region based on an operation by a user for selecting a range surrounding the target object from a still image. The still image is part of the video and includes the target object.

### BACKGROUND

### 1. Field

The present disclosure relates to a video analyzing device, a video analyzing method, and a non-transitory computer readable medium.

### 2. Description of Related Art

Japanese Laid-Open Patent Publication No. 2003-117045 discloses a swing form diagnosing device that extracts an impact point in time in a swing motion from a video of a golf swing, and displays the image. The diagnosing device disclosed in the publication extracts the impact point in time in the following manner. First, using a template of a golf ball that has been created in advance, a golf ball template matching process is performed to determine whether a golf ball is present or absent in each of consecutive still images in a video. Then, in the time series of the determination results, the time at which a ball presence determination (ball present in the image) is switched to a ball absence determination (ball absent in the image) is extracted as the impact point in time.

Since the diagnosing device of the publication needs to repeatedly perform the process of detecting a golf ball through template matching on a large number of still images in a video, the load on a device that performs the process is large. In particular, since a video of a golf swing shows the entire body of a golfer performing the swing, the golf ball shown in the video is relatively small. As the golf ball becomes smaller with respect to the size of the video, the amount of calculation for the process of detecting the golf ball increases for each still image. As a result, the load on the device that performs the process of detecting the golf ball is further increased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, a video analyzing device is configured to acquire information related to a motion of a target object based on a video showing the motion. The video is a moving image obtained by fixed-point recording of a process in which the target object at rest starts to move. The video analyzing device includes circuitry. The circuitry is configured to perform a video displaying process of displaying the video on a display screen of a display device, a region specifying process of specifying a part of a range shown in the video as a determination region, and an information acquiring process of acquiring the information based on a change in the specified determination region. The region specifying process includes specifying the part as the determination region based on an operation by a user for selecting a range surrounding the target object from a still image. The still image is part of the video and including the target object.

In a second general aspect, a video analyzing method for acquiring information related to a motion of a target object based on a video showing the motion is provided. The video is a moving image obtained by fixed-point recording of a process in which the target object at rest starts to move. The video analyzing method includes displaying the video on a display screen of a display device, specifying a part of a range shown in the video as a determination region, and acquiring the information based on a change in the specified determination region. The specifying the part includes specifying the part as the determination region based on an operation by a user for selecting a range surrounding the target object from a still image. The still image is part of the video and including the target object. The video analyzing method comprising, in the specifying the part, selecting a range surrounding the target object such that an area ratio of the target object to the determination region is 50% or more.

In a third general aspect, a non-transitory computer readable medium storing a program for causing a computer to function as a video analyzing device that acquires information related to a motion of a target object based on a video showing the motion is provided. The video is a moving image obtained by fixed-point recording of a process in which the target object at rest starts to move. The program causes the computer to perform a video displaying process of displaying the video on a display screen of a display device, a region specifying process of specifying a part of a range shown in the video as a determination region, and an information acquiring process of acquiring the information based on a change in the specified determination region. The region specifying process includes specifying the part as the determination region based on an operation by a user for selecting a range surrounding the target object from a still image, the still image being part of the video and including the target object.

Other features and aspects will be apparent from the following detailed description, the drawings, and the claims.

### BRIEF DESCRIPTION OF THE DRAWINGS

FIG. 1 is a block diagram of a video analyzing system.

FIG. 2 is an explanatory diagram showing a display screen in a region specifying step.

FIGS. 3A and 3B are explanatory diagrams showing the display screen in the region specifying step.

FIGS. 4A and 4B are explanatory diagrams showing the display screen after an information acquiring step.

FIG. 5 is an explanatory diagram of determination by an information acquiring unit.

FIG. 6 is a flowchart of a video analyzing method.

FIG. 7 is a flowchart of the region specifying step and the information acquiring step.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

<Video Analyzing System>

A video analyzing system 10 according to one embodiment will now be described. The video analyzing system 10 includes a video analyzing device 13. The video analyzing device 13 of the present embodiment acquires an impact point in time in a golf swing based on a video that captures the golf swing.

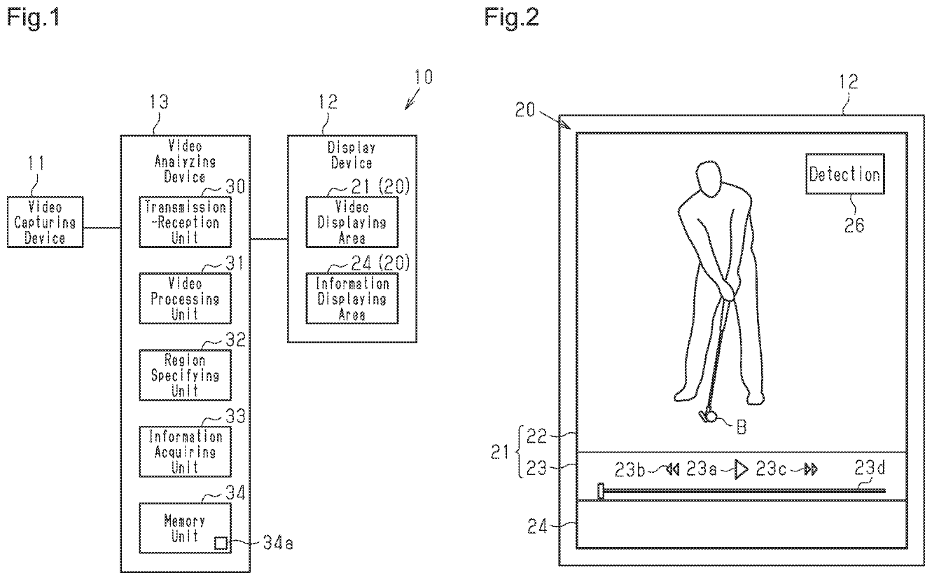

As shown in FIG. 1, the video analyzing system 10 includes a video capturing device 11, a display device 12, and the video analyzing device 13.

[Video Capturing Device]

The video capturing device 11 is not particularly limited as long as it captures a video of an area surrounding a golfer performing a golf swing and a golf ball by fixed-point recording. Examples of the video capturing device 11 include a video camera and a camera mounted on a mobile phone such as a smartphone or a tablet terminal. The video capturing device 11 is configured to output data of a video captured by fixed-point recording to the video analyzing device 13.

The video captured by the video capturing device 11 is a moving image including consecutive still images captured at a specified frame rate. The frame rate of the moving image is, for example, 30 FPS or 60 FPS. Further, the direction in which the video is captured is not particularly limited if it is a direction in which the golf ball is captured, and may be a direction from the front side of the golfer, a direction from the trailing side in the traveling direction of the hit ball, or a direction from the leading side in the traveling direction of the hit ball. The drawings show, as an example, a case in which the video is captured from the front side of the golfer.

[Display Device]

The display device 12 is, for example, a liquid crystal display or an organic EL display. The display device 12 is preferably a smartphone or a tablet terminal including a display screen.

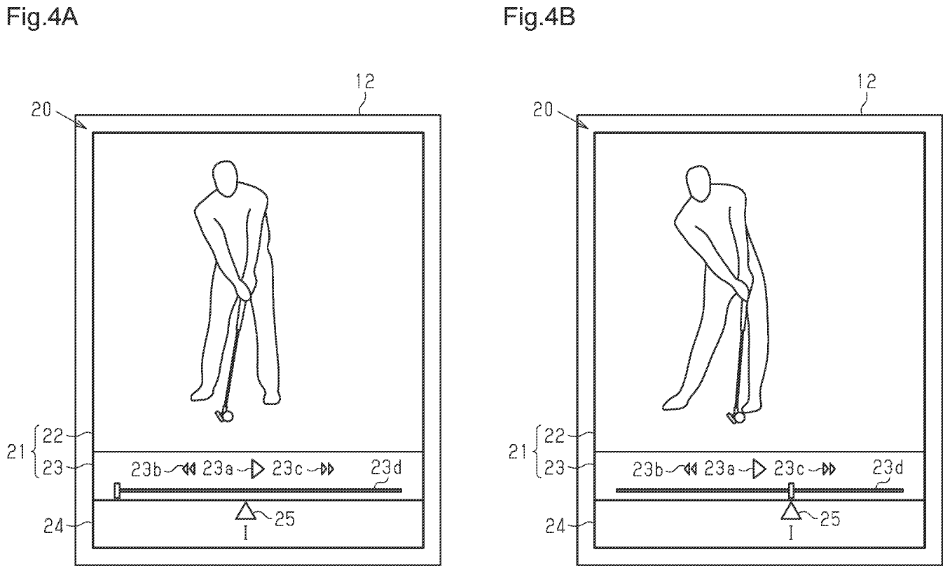

As shown in FIGS. 1, 4A, and 4B, the display device 12 includes a display screen 20, which displays contents controlled by the video analyzing device 13. The display screen 20 includes a video displaying area 21, which displays a video of a golf swing. The video displaying area 21 is provided with a video displaying section 22, which displays a video of a golf swing, and an operation section 23, which displays operation icons for operating the video displayed in the video displaying section 22. The operation icons displayed in the operation section 23 are a play/stop button 23a, a frame-by-frame reverse button 23b, a frame-by-frame forward button 23c, and a seek bar 23d. The operation icons are not particularly limited, and icons provided in known moving image playing software can be used.

The display screen 20 includes, in a lower section, an information displaying area 24 for displaying information based on the video being displayed on the video displaying area 21. The information displaying area 24 displays a point-in-time icon 25 indicating the position of an impact on the seek bar 23d. The point-in-time icon 25 is a point-in-time specifying button used to display a video at the time of an impact in the video displaying area 21 based on an operation input such as a click.

The operation icons displayed in the operation section 23 and the point-in-time icon 25 displayed in the information displaying area 24 are operated through, for example, an input operation using a pointing device (not shown) or a touch operation on a touch panel. The pointing device is, for example, a keyboard, a touch panel, or a mouse.

[Video Analyzing Device]

The video analyzing device 13 is, for example, a server, a personal computer (PC), a smartphone, a tablet terminal, or a combination thereof. The video analyzing device 13 is preferably capable of performing various processes in a stand-alone manner without using a communication network. For example, the video analyzing device 13 may be a personal computer (PC), a smartphone, or a tablet terminal. The video analyzing device 13 is preferably a smartphone or a tablet terminal having a function as the video capturing device 11 and a function as the display device 12.

As illustrated in FIG. 1, the video analyzing device 13 includes a transmission-reception unit 30, a video processing unit 31, a region specifying unit 32, an information acquiring unit 33, and a memory unit 34.

The transmission-reception unit 30 transmits and receives data between the video analyzing device 13 and the video capturing device 11 and between the video analyzing device 13 and the display device 12. The transmission-reception unit 30 includes a wired or wireless communication means, and performs mutual communication by a known communication method. Examples of the known communication method include near field communication such as Bluetooth (registered trademark) communication.

The video processing unit 31 performs a video displaying process of displaying a video of a golf swing input from the video capturing device 11 in the video displaying section 22 of the video displaying area 21 in the display device 12. The above-described process is performed at a point in time at which the video of the golf swing is input from the video capturing device 11 or at a point in time at which a specified operation by the user is performed on the video analyzing device 13, for example, an operation of loading a video of a golf swing stored in the memory unit 34 is performed.

The video processing unit 31 performs a process of displaying operation icons in the operation section 23 of the video displaying area 21. When an operation icon is operated, the video processing unit 31 performs a process of displaying a video corresponding to the content of the operation in the video displaying section 22, for example, playback, stop, frame-by-frame reverse, frame-by-frame forward, or change of a playback portion of a video.

The region specifying unit 32 performs a region specifying process on the video of a golf swing displayed in the video displaying section 22. Specifically, in the region specifying process, the region specifying unit 32 specifies a part of the range shown in the video as a determination region based on an operation by the user. As shown in FIG. 2, the region specifying unit 32 performs a process of displaying a region specifying button 26 in the video displaying section 22. The region specifying button 26 is displayed at a point in time at which the video displaying section 22 displays the video of a golf swing for which the process of acquiring the point in time of an impact has not been performed. At this time, the region specifying button 26 is shown as “Detection.” In the state shown in FIG. 2, the point-in-time icon 25 has not been displayed in the information displaying area 24.

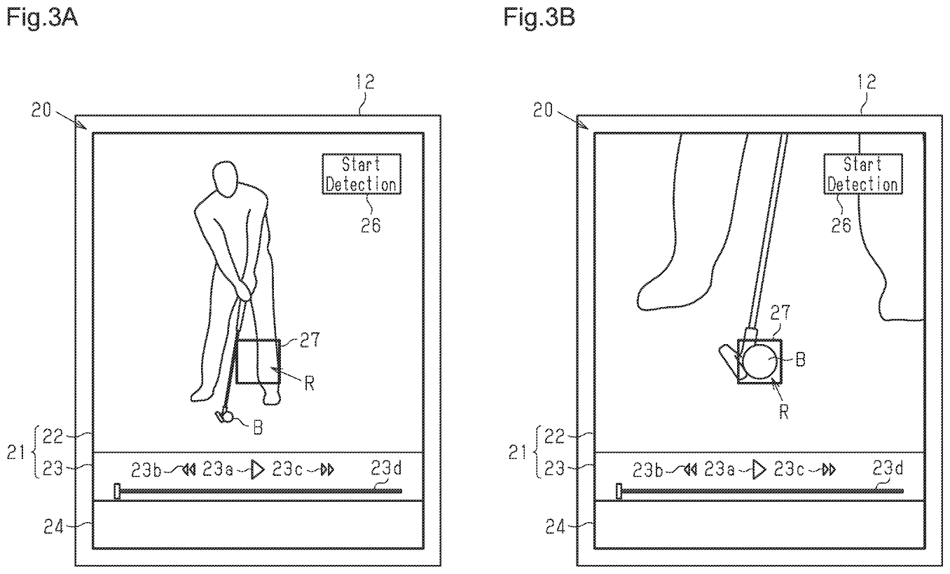

As shown in FIG. 3A, when the region specifying button 26 shown as “Detection” is operated, the region specifying unit 32 displays a specifying frame 27 for selecting a determination region R such that the specifying frame 27 is superimposed on a still image that is displayed in the video displaying section 22 at this point in time (hereinafter referred to as a target still image). The region specifying button 26 shown as “Detection” is operated in a state in which a still image shows a golf ball B before being hit.

The position, the shape, and the size of the specifying frame 27 are fixed in accordance with the size of the video displaying section 22. The position, the shape, and the size of the specifying frame 27 are not particularly limited. The shape of the specifying frame 27 is, for example, a rectangular shape, a polygonal shape, or a circular shape. The size of the specifying frame 27 is, for example, in a range of 40% to 80% of the size of the video displaying section 22. The drawings show, as an example, a case in which the specifying frame 27 having a square shape is displayed in a center lower portion of the video displaying section 22.

In addition, when the region specifying button 26 shown as “Detection” is operated, the region specifying unit 32 allows the target still image to be enlarged or reduced and translated in the video displaying section 22. That is, the region specifying unit 32 allows the target still image to be enlarged or reduced and translated by the user.

In this state, the user can adjust the range included in the specifying frame 27 in the target still image by operating the target still image. As will be described in detail below, as shown in FIG. 3B, the size and position of the target still image are adjusted by the user such that the golf ball B is included in the specifying frame 27, and the main object located in the specifying frame 27 is the golf ball B or the largest object other than the background is the golf ball B.

When the region specifying button 26 shown as “Detection” is operated, the region specifying button 26 is changed from “Detection” to “Start Detection.” When the region specifying button 26 shown as “Start Detection” is operated, the region specifying unit 32 specifies, as the determination area R, the same range as the range included in the specifying frame 27 in the target still image, for each of multiple still images in the golf swing video. For example, the region specifying unit 32 obtains a range of XY coordinates (X1 to X2, Y1 to Y2) in which the range included in the specifying frame 27 in the target still image is located. Then, for each of multiple still images in the video of the golf swing, the region specifying unit 32 specifies, as the determination region R, a part corresponding to the range (X1 to X2, Y1 to Y2) of the obtained XY coordinates. The multiple still images may be all of the still images in the video of the golf swing, or may be some of the still images extracted at a preset cycle.

When the region specifying button 26 shown as “Start Detection” is operated, the target still image in the video displaying section 22 returns to the display state of the time before the region specifying button 26 shown as “Detection” was operated. The region specifying unit 32 does not accept any input of an operation on the operation section 23 during a period from when the region specifying button 26 shown as “Detection” is operated to when the region specifying button 26 shown as “Start Detection” is operated.

When the determination region R is specified by the region specifying unit 32, the information acquiring unit 33 performs information acquiring process of acquiring the point in time of an impact. The information acquiring unit 33 determines whether the state in which the golf ball B is in the determination region R is maintained for the multiple still images in which the determination region R is specified.

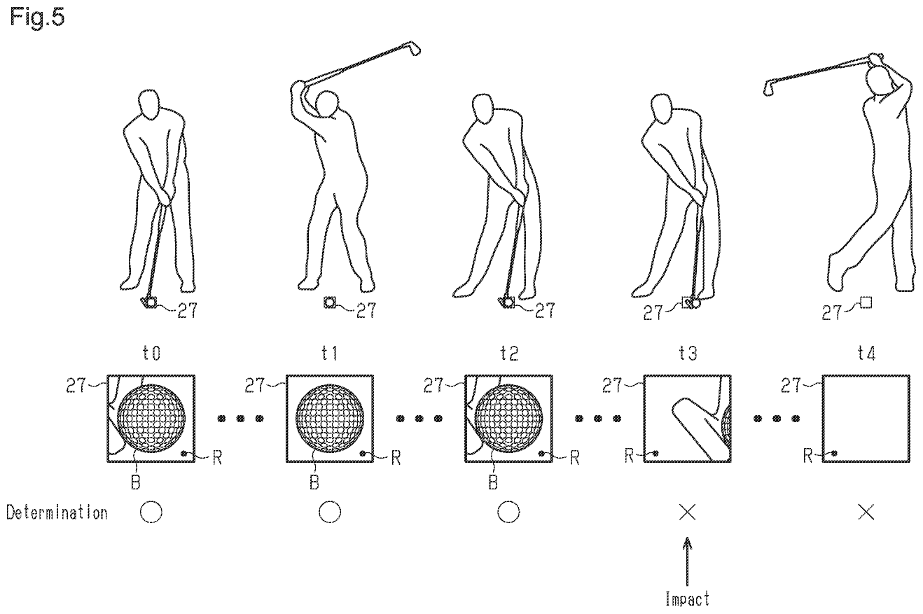

FIG. 5 shows still images at respective points in time regarded as important in a golf swing, extracted from the still images in the video of the golf swing and arranged in time series. The determination region R in each still image is also shown. The points in time include the address (t0), the top of backswing (t1), the impact (t2, t3), and the finish (t4). From the address (t0) to the impact (t2), a state in which the golf ball B is in the determination region R is maintained. After the impact (t3), since the golf ball B is shot, the state in which the golf ball B is in the determination region R is no longer maintained.

The above-described determination utilizes an object tracking technique for tracking the position of an object. Specifically, object tracking with a pretrained AI model is performed only for the determination region R of multiple still images in the video of the golf swing. At this time, by setting the largest object present in the determination region R as the golf ball B, the target of the object tracking becomes the golf ball B without performing a matching process.

The AI model outputs the tracking result of each of the still images including the golf ball B in the determination region R, and outputs a signal indicating that tracking is not possible for still images in which the golf ball B is not in the determination region R. When the tracking result is output, the information acquiring unit 33 makes a ball presence determination, that is, determines that the golf ball B is displayed. When a signal indicating that tracking is not possible is output, the information acquiring unit 33 makes a ball absence determination, that is, determines that the golf ball B is not displayed. The AI model may be included in the information acquiring unit 33, or may be included in a PC, a smartphone, a tablet terminal, or the like that is used as the video analyzing device 13.

As shown in FIG. 5, the information acquiring unit 33 detects a point in time (t3) of the still image at which a ball presence determination (o) is switched to a ball absence determination (x) in the time series of the determination results, and acquires the detected point in time as an impact point in time. After acquiring the impact point in time, the information acquiring unit 33 displays the point-in-time icon 25 in the information displaying area 24 as shown in FIGS. 4A and 4B. The point-in-time icon 25 is displayed below the time point corresponding to the acquired impact point in time on the seek bar 23d.

The video processing unit 31, the region specifying unit 32, and the information acquiring unit 33 may be circuitry including one or more processors that operate according to a computer program (software), one or more dedicated hardware circuits (application specific integrated circuits: ASIC) that perform at least part of various processes or a combination thereof.

The memory unit 34 stores data of the video of the golf swing input from the video capturing device 11, and stores the acquired impact point in time in association with the data of the video from which the impact point in time has been acquired. The memory unit 34 also stores a program 34a for controlling execution of each process in the video processing unit 31, the region specifying unit 32, and the information acquiring unit 33. The program 34a corresponds to a program for causing a computer to function as the video analyzing device 13.

<Video Analyzing Method>

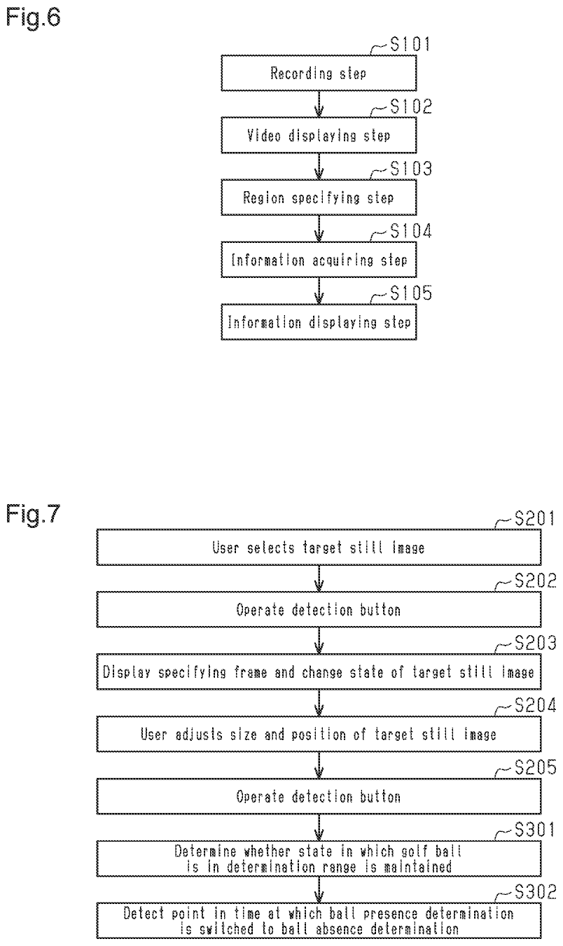

Next, a video analyzing method using the video analyzing system 10 of the present embodiment will be described with reference to FIG. 6. In the video analyzing method, steps S101 to S105 described below are performed sequentially.

Step S101 is a recording step of recording a video of a golf swing using the video capturing device 11. The recorded video is a moving image acquired by performing fixed-point recording on an area surrounding a golfer who performs a golf swing and the golf ball B. Step S102 is a video processing step of displaying the video of the golf swing recorded by the video capturing device 11 in the video displaying section 22 of the display device 12. At this time, the video displayed in the video displaying section 22 is a video on which the process of acquiring the impact point in time has not been performed.

Step S103 is a region specifying step of specifying a part of the range shown in the video displayed in the video displaying section 22 as the determination region R based on an operation by the user. Step S104 is an information acquiring step of acquiring the impact point in time from the video of the golf swing based on a change in the determination region R, which has been specified in step S103. Details of the region specifying step and the information acquiring step will be described below.

Step S105 is an information displaying step of displaying the point-in-time icon 25 in the information displaying area 24 of the display device 12. As shown in FIG. 4A, the information acquiring unit 33 displays the point-in-time icon 25 in the information displaying area 24. As shown in FIG. 4B, when the point-in-time icon 25 is operated, the information acquiring unit 33 displays a still image at the impact point in time in the video displaying area 21.

Next, details of the region specifying step and the information acquiring step will be described with reference to FIG. 7.

In the region specifying step, which is step S103, first, a target still image is selected by the user (step S201). The user operates an operation icon displayed in the operation section 23 of the display device 12 so that a still image showing the golf ball B before being hit is displayed in the video displaying section 22.

Thereafter, the user operates the region specifying button 26 shown as “Detection”, which is displayed in the video displaying section 22 (step S202). When the region specifying button 26 is operated, the region specifying unit 32 displays the specifying frame 27 such that the specifying frame 27 is superimposed on the target still image displayed in the video displaying section 22, and changes the display state of the target still image (step S203). In step S203, the target still image is changed to a state in which it can be enlarged or reduced and translated in the video displaying section 22.

Next, the user adjusts the size and position of the target still image so that the entire golf ball B is included in the specifying frame 27 (step S204). At this time, the user adjusts the size and position of the target still image such that the main object located in the specifying frame 27 is the golf ball B or the largest object other than the background is the golf ball B. In particular, it is preferable to adjust the size and position of the target still image such that the area ratio of the golf ball B to the specifying frame 27 after the adjustment is 50% or more. Further, it is preferable to adjust the size and position of the target still image such that the background of the golf ball B is included in the specifying frame 27 after the adjustment. For example, the size and position of the target still image are adjusted such that the area ratio of the background to the specifying frame 27 is 40% or more. When the size and position of the target still image are adjusted such that one or both of the above requirements regarding the area ratio of the golf ball B and the area ratio of the background are satisfied, the accuracy of the determination process by the information acquiring unit 33 is improved. The operation for adjusting the size and position of the target still image is performed by, for example, an input operation using a pointing device or a touch operation on a touch panel.

Thereafter, the user operates the region specifying button 26 shown as “Detection Start” in the video displaying section 22 (step S205). When the region specifying button 26 is operated, the region specifying unit 32 specifies, as the determination area R, the same range as the range included in the specifying frame 27 in the target still image, for each of multiple still images in the golf swing video. Thereafter, an information acquiring step, which is a step S104, is performed.

In the information acquiring step, first, a determination process is performed by the information acquiring unit 33. The information acquiring unit 33 determines whether a state in which the golf ball B is in the determination region R is maintained for the multiple still images in which the determination region R is specified (step S301). Thereafter, the information acquiring unit 33 detects a point in time of the still image at which the ball presence determination is switched to the ball absence determination in the time series of the determination results, and acquires the detected point in time as an impact point in time (step S302). After step S302, an information displaying step, which is step S105, is performed.

Operation and advantages of the present embodiment will now be described.

(1) The video analyzing device 13 includes the video processing unit 31, the region specifying unit 32, and the information acquiring unit 33. The video processing unit 31 displays a video of a golf swing, which is a moving image obtained by fixed-point recording, on the display screen 20 of the display device 12. The region specifying unit 32 specifies a part of a range shown in the video as a determination region R. The information acquiring unit 33 acquires the point in time of impact based on a change in the specified determination region R. The region specifying unit 32 specifies the determination region R based on an operation by a user for selecting a range surrounding the ball B in a still image that is part of the video and includes the ball B.

The above-described configuration performs a process of acquiring the impact point in time for the determination region R specified by the user. This configuration reduces the load of processes performed by the devices, as compared to a case in which the impact point in time is acquired for the entire still image, that is, for the entire area inside and outside the determination region R. The above-described configuration additionally includes the process for specifying the determination region R. However, since the user selects the position and size of the determination region R, the process is a simple one that does not involve determination based on an AI model or the like.

Therefore, the above-described configuration allows for reduction in the load applied to the device that is caused to perform the process of acquiring the impact point in time. As a result, it is possible to reduce the time required for the process of acquiring the impact point in time and to suppress the heat generation of the device due to the process.

In addition, the above-described configuration allows the impact point in time to be acquired in the same way even if the size, particularly the size of the golf ball B in the video, varies for each video. Therefore, it is possible to acquire the impact point in time in correspondence with videos of various sizes.

(2) The region specifying unit 32 displays the specifying frame 27 for selecting the determination region R such that the specifying frame 27 is superimposed on the still image displayed on the display screen 20. The size and position of the specifying frame 27 relative to the target still image can be changed based on an operation by the user. In the present embodiment, the position and the size of the specifying frame 27 are fixed, and the target still image can be enlarged or reduced or translated.

The above-described configuration allows the user to perform the operation of selecting the range surrounding the golf ball B with respect to the target still image. In particular, since the target still image can be enlarged or reduced and translated, an appropriate range surrounding the golf ball B can be selected even when the golf ball B is shown in a small size.

(3) The information acquiring unit 33 determines whether the state in which the golf ball B is in the determination region R is maintained for the multiple still images in which the determination region R is specified in the video of a golf swing, and acquires the impact point in time based on a change in the determination result.

The above-described configuration acquires the impact point in time through a simple determination process. This reduces the load applied to the device that is caused to perform the process of acquiring the impact point in time.

(4) The range surrounding the golf ball B is selected such that the main object located in the determination region R is the golf ball B, or the area ratio of the golf ball B to the determination region R, that is, the area ratio of the golf ball B to the specifying frame 27 is 50% or more.

Since the determination region R is relatively small in the above-described configuration, the advantage of reducing the load of the processes performed by the devices, which is the above-described advantage (1), is more remarkable. With above-described configuration, the largest object present in the determination region R is the golf ball B. In this case, the object detected in the determination region R can be regarded as the golf ball B. Therefore, when it is determined whether the golf ball B exists in the determination region R, it is only necessary to determine whether an object is detected in the determination region R, and it is not necessary to determine whether the detected object is the golf ball B.

(5) The processes of the information acquiring unit 33 are performed in a stand-alone manner without using a communication network.

This configuration reduces the communication costs and the processing time. In some cases, a video of a golf swing can be personal data that is used to identify the golfer. Therefore, it is possible to prevent the user from feeling a sense of aversion to transmitting the personal information to the outside.

The above-described embodiment may be modified as follows. The above-described embodiment and the following modifications can be combined if the combined modifications remain technically consistent with each other.

The configuration for changing the size and position of the specifying frame 27 relative to the target still image is not limited to that in the above-described embodiment. For example, the target still image may be fixed, and the size and position of the specifying frame 27 may be changeable. In addition, instead of the configuration that allows the size and position of the specifying frame 27 displayed to be superimposed on the target still image to changed relatively, a configuration may be employed in which the specifying frame 27 may be drawn to have any shape based on an operation by the user.

In the determination process of the information acquiring step, a point in time of a still image several frames before the still image at which a ball presence determination is switched to a ball absence determination may be defined as the impact point in time.

The video analyzing device 13 may perform further analysis based on the acquired impact point in time. For example, the video analyzing device 13 may use the acquired impact point in time as a reference point, and may perform a process of cutting out a video of several frames before and after the reference point as a video of one swing. In addition, the video analyzing device 13 may acquire a point in time several frames before the reference point and a point in time several frames after the reference point as the point in time of the top of swing back and the point in time of the finish of swing, respectively.

The method of determining whether the state in which the golf ball B is in the determination region R is maintained is not limited to the method using the object tracking technology. As another determination method, for example, a determination method using a color histogram may be used. Specifically, for multiple still images in which the determination region R is set, a color histogram in the determination region R is created, and it is determined whether a change amount of the color histogram is less than or equal to a preset threshold in comparison with a still image of the previous frame. For a still image in which the amount of change in the color histogram is less than or equal to the threshold, a ball presence determination is made, that is, it is determined that the golf ball B is displayed. For a still image in which the amount of change in the color histogram exceeds the threshold is determined, a ball absence determination is made, that is it is determined that the golf ball B is not displayed.

The information acquired from a video of a golf swing is not limited to the point in time of impact on the golf ball B. For example, when the object tracking technology is used, it is also possible to acquire other information related to the start of movement of the golf ball B, such as the initial velocity when the golf ball B is hit, the launch angle of the golf ball B, and the like.

A video to be analyzed by the video analyzing device 13 is not limited to a video of a golf swing. Any video of a process in which a stationary object starts moving may be analyzed by the video analyzing device 13. Examples of such other videos include a video of a free kick in soccer, a video of a swing in gateball, a video of tee ball hitting in baseball, and a video of a start of running using a starting block in sprinting or the like.

In addition, as a reference example, the video analyzing device 13 may be used to analyze a video other than a video in a process in which a stationary object starts to move. For example, as in a case in which information on whether the head of a golfer is moving is acquired based on a video of a golf swing, it is possible to acquire information on a motion of a part of the body of a golfer as an object. In this case, the determination region R is set so as to select a range surrounding part of the body of the golfer. In addition, in a video of a basketball shot, it is also possible to acquire information related to a motion with respect to a stationary object, as in a case in which information related to a point in time at which a ball passes through a goal is acquired. In this case, the determination region R is set to select a range surrounding the stationary object.

The determination process of the information acquiring step may be performed by a server or a cloud using a communication network.

The video to be analyzed by the video analyzing device 13 may be a video captured by a video capturing device other than the video capturing device 11 included in the video analyzing system 10.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A video analyzing device configured to acquire information related to a motion of a target object based on a video showing the motion, wherein the video is a moving image obtained by fixed-point recording of a process in which the target object at rest starts to move, the video analyzing device comprises circuitry, the circuitry being configured to perform:
a video displaying process of displaying the video on a display screen of a display device;
a region specifying process of specifying a part of a range shown in the video as a determination region; and
an information acquiring process of acquiring the information based on a change in the specified determination region, and
wherein the region specifying process includes specifying the part as the determination region based on an operation by a user for selecting a range surrounding the target object from a still image, the still image being part of the video and including the target object.

2. The video analyzing device according to claim 1, wherein the video is a video of a golf swing.

3. The video analyzing device according to claim 1, wherein
the region specifying process includes displaying a specifying frame for selecting the determination region such that the specifying frame is superimposed on the still image displayed on the display screen, and
the specifying frame is displayed such that a size and a position of the specifying frame relative to the still image is changeable based on an operation by the user.

4. The video analyzing device according to claim 3, wherein the information acquiring process includes:
determining whether a state in which the target object is in the determination region is maintained for multiple still images in the video; and
acquiring a point in time of the start of the motion of the target object based on a change in a result of the determination.

5. The video analyzing device according to claim 1, wherein the video analyzing device performs the information acquiring process in a stand-alone manner without using a communication network.

6. A video analyzing method for acquiring information related to a motion of a target object based on a video showing the motion, wherein the video is a moving image obtained by fixed-point recording of a process in which the target object at rest starts to move, the video analyzing method comprises:
displaying the video on a display screen of a display device;
specifying a part of a range shown in the video as a determination region; and
acquiring the information based on a change in the specified determination region, and
wherein the specifying the part includes specifying the part as the determination region based on an operation by a user for selecting a range surrounding the target object from a still image, the still image being part of the video and including the target object, and
the video analyzing method comprising, in the specifying the part, selecting a range surrounding the target object such that an area ratio of the target object to the determination region is 50% or more.

7. A non-transitory computer readable medium storing a program for causing a computer to function as a video analyzing device that acquires information related to a motion of a target object based on a video showing the motion, wherein the video is a moving image obtained by fixed-point recording of a process in which the target object at rest starts to move, the program causes the computer to perform:
a video displaying process of displaying the video on a display screen of a display device;
a region specifying process of specifying a part of a range shown in the video as a determination region; and
an information acquiring process of acquiring the information based on a change in the specified determination region, and
wherein the region specifying process includes specifying the part as the determination region based on an operation by a user for selecting a range surrounding the target object from a still image, the still image being part of the video and including the target object.
